(19) United States
(12) Patent Application Publication
(10) Pub. No.: US 2012/0185638 A1
(43) Pub. Date: Jul. 19, 2012

(54) METHOD AND SYSTEM FOR CACHE ENDURANCE MANAGEMENT

(76) Inventors: Daniel Schreiber, Jerusalem (IL); Robert K. Khedouri, Roslyn, NY (US); Judah Gamliel Hahn, Ofra (IL)

(21) Appl. No.: 13/074,730

(22) Filed: Mar. 29, 2011

Related U.S. Application Data
(60) Provisional application No. 61/432,975, filed on Jan. 14, 2011.

(51) Int. Cl. G06F 12/00

(52) U.S. Cl. 711/103; 711/E12.008

(57) ABSTRACT

A system and method for cache endurance management is disclosed. The method may include the steps of querying a storage device with a host to acquire information relevant to a predicted remaining lifetime of the storage device, determining a download policy modification for the host in view of the predicted remaining lifetime of the storage device and updating the download policy database of a download manager in accordance with the determined download policy modification.

### CROSS-REFERENCE TO RELATED APPLICATIONS

This application claims the benefit of U.S. Application No. 61/432,975, filed Jan. 14, 2011, the entirety of which is incorporated herein by reference.

### BACKGROUND

Non-volatile memory systems, such as flash memory, have been widely adopted for use in consumer products. Flash memory may be found in different forms, for example in the form of a portable memory card that can be carried between host devices or as a solid state disk (SSD) embedded in a host device. Two general memory cell architectures found in flash memory include NOR and NAND. In a typical NOR architecture, memory cells are connected between adjacent bit line source and drain diffusions that extend in a column direction with control gates connected to word lines extending along rows of cells. A memory cell includes at least one storage element positioned over at least a portion of the cell channel region between the source and drain. A programmed level of charge on the storage elements thus controls an operating characteristic of the cells, which can then be read by applying appropriate voltages to the addressed memory cells.

A typical NAND architecture utilizes strings of more than two series-connected memory cells, such as 16 or 32, connected along with one or more select transistors between individual bit lines and a reference potential to form columns of cells. Word lines extend across cells within many of these columns. An individual cell within a column is read and verified during programming by causing the remaining cells in the string to be turned on so that the current flowing through a string is dependent upon the level of charge stored in the addressed cell.

The responsiveness of flash memory cells typically changes over time as a function of the number of times the cells are erased and re-programmed As this generally results in the memory cells becoming less reliable, the memory cells may need higher voltages for erasing and programming as they age. The effective threshold voltage window over which the memory states may be programmed can also decrease as a result of this charge retention. The result is a limited effective lifetime of the memory cells. Specifically, blocks of memory cells may be subjected to only a preset number of Write and Erase cycles before they are mapped out of the system. The number of cycles to which a flash memory block is desirably subjected may depend upon the particular structure of the memory cells, the amount of the threshold window that is used for the storage states, the extent of the threshold window usually increasing as the number of storage states of each cell is increased. Depending upon these and other factors, the number of lifetime cycles can be as low as 10,000 and as high as 100,000 or even several hundred thousand.

Continual erasing and re-programming of data sectors in a relatively few logical block addresses may occur where the host continually updates certain sectors of housekeeping data stored in the memory, such as file allocation tables (FATs) and the like. Specific applications can also cause a few logical blocks to be re-written much more frequently than others with user data. Therefore, in response to receiving a command from the host to write data to a specified logical block address, the data are written to one of a few blocks of a pool of erased blocks. That is, instead of re-writing the data in the same physical block where the original data of the same logical block address resides, the logical block address is remapped into a block of the erased block pool. The block containing the original and now invalid data is then erased either immediately or as part of a later garbage collection operation, and then placed into the erased block pool. The result is that even when data in only a few logical block addresses are being updated much more than other blocks, instead of a relatively few physical blocks of the system being cycled with a higher rate, the cycling is evenly spread over many physical blocks. This technique is known in the prior art as “wear leveling”.

During normal reads and writes based on user-driven actions, the lifetime of a flash memory is typically manageable using standard wear leveling technology. However, in systems that employ automated, system-driven downloading of data, massive writes may occur on a frequent basis in a flash memory. These types of downloads, sometimes referred to as caching, can occur in systems where a host device includes an application for automatically downloading, storing and then refreshing data such as movies, television shows and other video clips to a storage device in anticipation of a user later playing back the downloaded or “cached” data. The system-driven high volume of downloaded data with frequent refresh or overwrites can lead to a severe reduction in endurance and longevity of a flash storage device.

### SUMMARY

In order to address the problem of prematurely wearing out the limited write/erase cycles of flash memory due to system-driven caching or refreshing of large quantities of data on a regular basis, a system and method for managing cache endurance is disclosed.

According to one aspect, a method is disclosed for a host system having a non-volatile memory containing a download manager and a download policy database, as well as a processor configured to download data from a data source to a storage device in communication with the host device in accordance with the policy database. The processor receives information from the storage device related to a model of the storage device. The processor then calculates a predicted remaining lifetime of the storage device based on the received information, determines a modification of the download policy database based on the calculated predicted lifetime, and updates the download policy of the download manager in accordance with the modification to compensate for the reduced lifetime.

According to another aspect, a method is disclosed for a host system having a non-volatile memory containing a download manager and a download policy database, as well as a processor configured to download data from a data source to a storage device in communication with the host device in accordance with the policy database. The processor requests information from the storage device related to a predicted remaining lifetime of the storage device. The processor of the host then determines a modification of the download policy database based on the predicted remaining lifetime, and updates the download policy manager in accordance with the modification. The updates to the policy database may include limitations to download speed, daily download capacity, ceasing all downloading via the download manager and/or notifying the user of limited remaining ability to cache data downloaded via the download manager.

### BRIEF DESCRIPTION OF THE DRAWINGS

FIG. 1 is a block diagram of a system that may implement aspects of the invention.

FIG. 2 illustrates an example physical memory organization of the storage device of FIG. 1.

FIG. 3 shows an expanded view of a portion of the physical memory of FIG. 2.

FIG. 4 is a flow diagram illustrating a method of managing cache endurance.

FIG. 5 illustrates an example of a download policy modification table for use in the method of FIG. 4.

FIG. 6 is a flow diagram illustrating an alternative implementation of the method of FIG. 4

### DETAILED DESCRIPTION OF THE PRESENTLY PREFERRED EMBODIMENTS

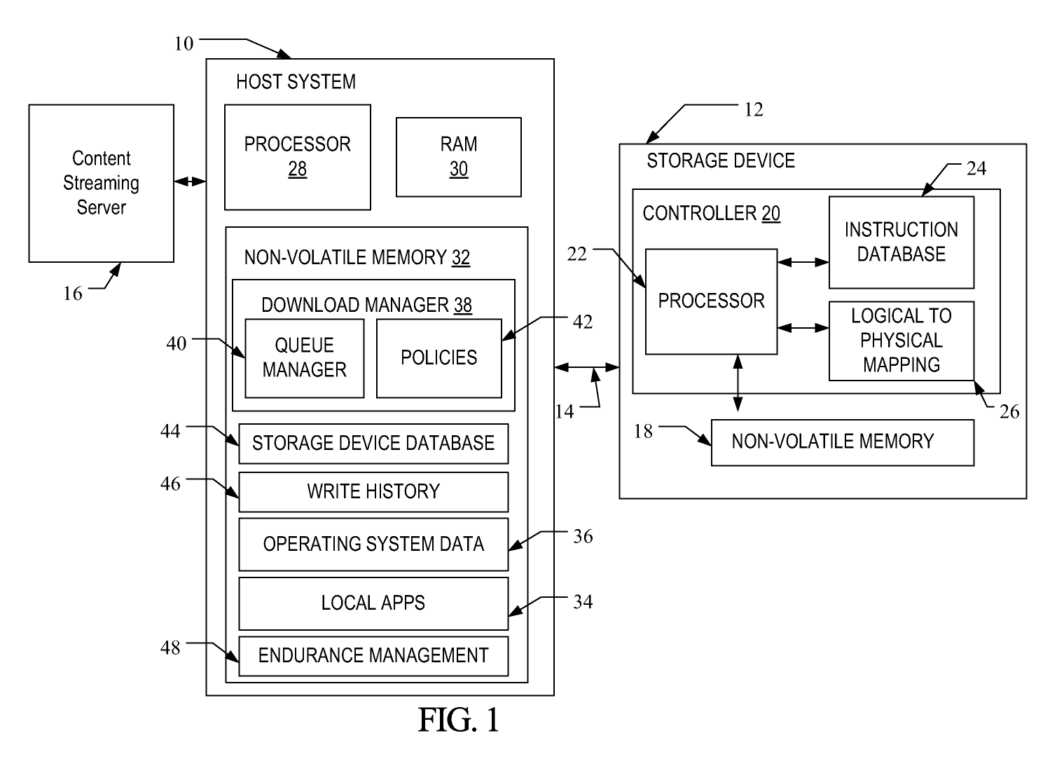

A system suitable for use in implementing aspects of the invention is shown in FIG. 1. A host system 10 controls data stored into and retrieved from a physical storage device 12. The storage device 12 may be a flash device embedded in the host, may be an external storage device, or may exist in the form of a card or other removable flash drive that is removably connected to the host 10 through a mechanical and electrical connector or a wireless connection. The host 10 may be any of a number of data handling devices, such as a tablet computer, mobile phone, personal digital assistant, home network router, or a personal computer. The host 10 communicates with the storage device over a communication channel 14. The host 10 communicates with one or more content streaming servers 16 via a network interface. The communication channel 14 and network interface may any of a number of available wired or wireless interfaces.

The storage device 12 contains non-volatile memory 18. The non-volatile memory 18 may be configured in a single level cell (SLC) type of flash configuration, a multi-level cell (MLC) type flash memory configuration or a combination of these or other flash types. The storage device 12 also includes a controller 20 that may include a processor 22, instructions 24 for operating the processor 22 and a logical block to physical block translation table 26.

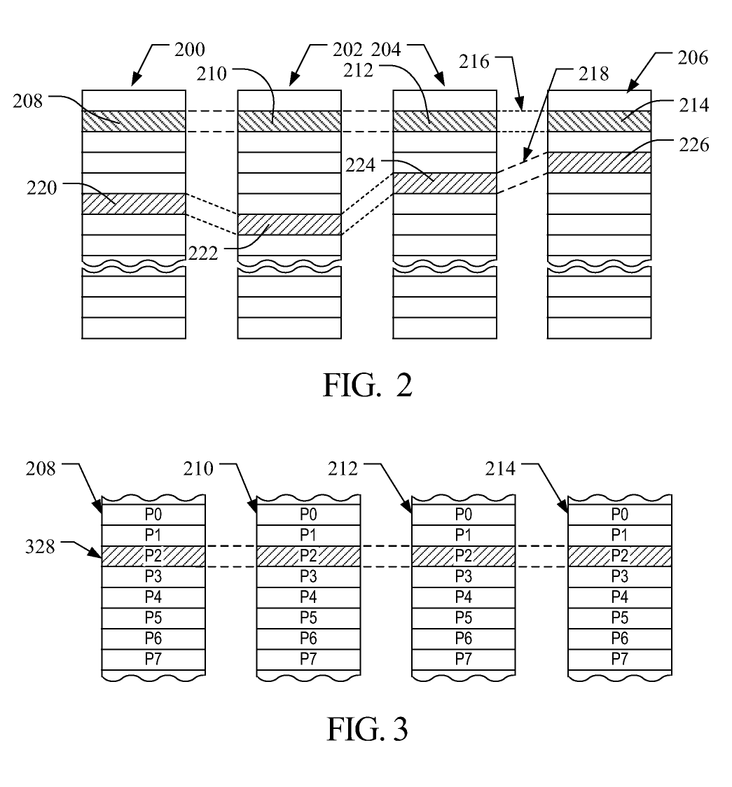

The non-volatile flash memory may be arranged in blocks of memory cells. A block of memory cells is the unit of erase, i.e., the smallest number of memory cells that are physically erasable together. For increased parallelism, however, the blocks may be operated in larger metablock units. One block from each plane of memory cells may be logically linked together to form a metablock. Referring to FIG. 2, a conceptual illustration of a representative flash memory cell array is shown. Four planes or sub-arrays 200, 202, 204 and 206 memory cells may be on a single integrated memory cell chip, on two chips (two of the planes on each chip) or on four separate chips. The specific arrangement is not important to the discussion below and other numbers of planes may exist in a system. The planes are individually divided into blocks of memory cells shown in FIG. 2 by rectangles, such as blocks 208, 210, 212 and 214, located in respective planes 200, 202, 204 and 206. There may be dozens or hundreds of blocks in each plane. Blocks may be logically linked together to form a metablock that may be erased as a single unit. For example, blocks 208, 210, 212 and 214 may form a first metablock 216. The blocks used to form a metablock need not be restricted to the same relative locations within their respective planes, as is shown in the second metablock 218 made up of blocks 220, 222, 224 and 226.

The individual blocks are in turn divided for operational purposes into pages of memory cells, as illustrated in FIG. 3. The memory cells of each of blocks 208, 210, 212, and 214, for example, are each divided into eight pages P0-P7. Alternately, there may be 16, 32 or more pages of memory cells within each block. A page is the unit of data programming and reading within a block, containing the minimum amount of data that are programmed or read at one time. A metapage 328 is illustrated in FIG. 3 as formed of one physical page for each of the four blocks 208, 210, 212 and 214. The metapage 328 includes the page P2 in each of the four blocks but the pages of a metapage need not necessarily have the same relative position within each of the blocks. A metapage is the maximum unit of programming. The blocks disclosed in FIGS. 2-3 are referred to herein as physical blocks because they relate to groups of physical memory cells as discussed above. As used herein, a logical block is a virtual unit of address space defined to have the same size as a physical block. Each logical block includes a range of logical block addresses (LBAs) that are associated with data received from a host 10. The LBAs are then mapped to one or more physical blocks in the storage device 12 where the data is physically stored.

Referring again to FIG. 1, the host system 10 includes a processor 28 and random access memory (RAM) 30. Non-volatile memory 32 in the host system 10 may include various local applications 34 and operating system data 36. The host system 10 may include a download manager 38 in memory 32 that handles system-generated downloads of content from remote locations. Although FIG. 1 illustrates downloading streamed content from content servers such as content streaming server 16, any of a number of types of content may be handled by the download manager 38. The download manager 38 may include a queue manager 40 which may contain a list of content or content addresses (e.g. URI or URL information) in a prioritized manner that reflects either user-selected or system-selected resources for downloading desired content into storage device 12. The download manager 38 may be one or more applications or a combination of hardware and software on the host 10. The download manager 38 is configured to handle download of data from remote sources and may be configured to permit the host to automatically download selected items from remote sources at user-selected times or based on user or system generated rules. The download manager may be implemented with any one of a number of available operating system components intended for download management from remote sources, such as the ANDROID download manager available from GOOGLE, INC.

A policy database 42 in the download manager 38 may contain rules for downloading streamed data from the content streaming server or servers 16. These rules may include desired time of day for downloading information, required connection rate for downloading one or more of the items in the queue 40, total amount of downloaded content per a given time period or a maximum download rate permitted for streamed content to be downloaded to the storage device 12. The system 10 may also include a storage device database 44 which may contain flash endurance-related information correlated to storage device type/model information. For example, a storage device database 44 may contain a list of flash memory card types for removable storage cards that lists the total number of writes the memory card is specified for, the block size and the alignment of the blocks for each particular type of storage device identified in the storage device database 44. Additionally, the host system 10 includes a write history database 46 that tracks the number of write operations to a particular storage device 12. Finally, the non-volatile memory 32 of the host system 10 includes an endurance management module 48 containing processor executable instructions for determining a remaining life of the storage device 12 and modifying policies 42 of the download manager 38 in view of the predicted remaining lifetime of the storage device.

As noted above, a role of the download manager 38 application is to handle downloading of content from content server 16 to the storage device 12. One manner in which the download manager 38 may enhance the experience of a user of the host device 10 is by providing a mechanism for caching streamed video data from television shows, news or movies in the storage device 12 so that the user may view an high quality version of the desired data from local storage device 12 rather than having to try and stream the same data on-demand from the content streaming server when connection speed, connectivity generally, download costs and so on may impact the experience. In order to implement the scheduled downloading of data to storage device 12, the queue manager 40 of the download manager 38 may include a list of user-selected video sources prioritized by user preferences and the policies 42 in the download manager 38 may include criteria by which the host system 10 will automatically load and/or refresh videos from those selected sources.

As an example, a user may have previously selected to have the latest weekly episode of a television show downloaded and cached automatically in the storage device 12 from a content streaming server 16. The download manger 38 would then download from the source identified in the queue manager 40, based on the rules for that source set out in the policies database 42, a streamed episode to be cached in the storage device 12. The rules in the policy database pertaining to the source may be to only download and store the latest episode after a certain date when the host system 10 is otherwise idle, or to download and store the episode when the host device is in communication with a content streaming server 16 over an advantageous type of network connection, or so on. A second content source added to the queue manager by a user for download by the host device may be a source that generates sports highlight video clips with the latest sports clips updated on an hourly basis. The rules in the policies database 42 may direct the host system 10 to, for example, refresh and download the latest clip on the hour such that the streamed video clip is refreshed in the storage device 12 on the hour. The same or different download parameters for each information source in the queue 40 may be maintained in the policy database 42. Unlike the typical user-driven activity of storing information on a storage device 12 from the host system 10, this frequent system-driven downloading of large volumes of data can radically affect the useful lifespan of the storage device 12.

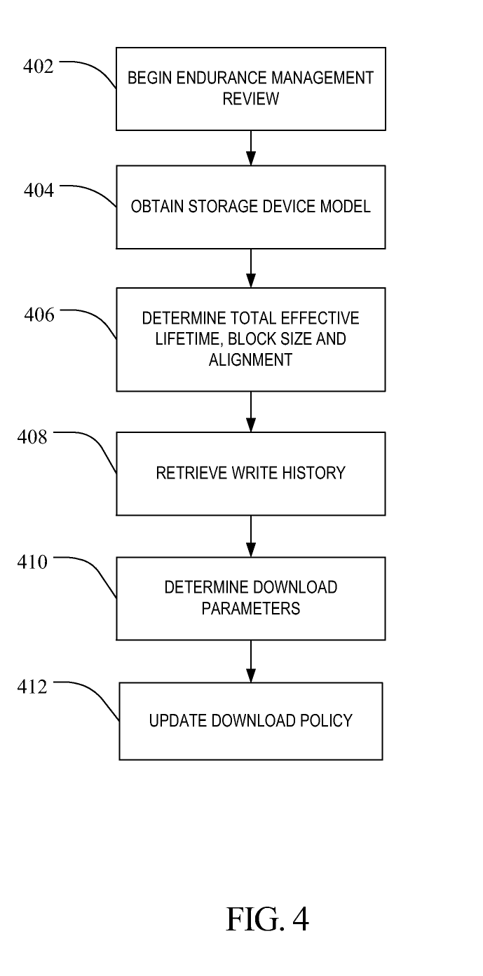

An endurance management function described below may assist in prolonging the endurance of a storage device attached to a host system 10 having a download manager 38 described above. As illustrated in FIG. 4, the processor 28 of the host system 10 may execute instructions from an endurance management module 48 that allows the host device 10 to predict or obtain a prediction of a remaining life of the storage device 12 and then modify the download policies 42 as the remaining life of the storage becomes limited. The host system may initiate the cache management process by performing a check of the endurance of the storage device 12 periodically or in response to specific triggers. In one implementation, the host system 10 will check on the status of the storage device through the endurance management module at power-up and may be triggered to check again on the status of a storage device each time a new item is added to the queue manager 40, immediately before a download cycle of streamed content by the download manager is started, or at other desired intervals.

Referring to FIG. 4, when the endurance management review begins (at 402) the host system 10 queries the storage device 12 via the driver on the host associated with the particular storage device 12. The host system 10 then receives the storage device information from the storage device 12 in a format supported by the driver for the particular storage device to allow the host to determine the effective life and predict a remaining life of the storage device 12 (at 404). The storage device information may include storage card model information, block size information and block alignment information. Once the host system 10 receives the storage device model information, the host system 10 compares that model to models listed in its storage device database 42, which may include a simple look-up table, to find out the total number of writes, block size and the alignment offset implemented on the type of card detected (at 406). In the example of FIG. 4, the storage device is assumed to be a memory card that cannot provide details of its remaining lifespan and/or calculate remaining life on its own. In this implementation, the instructions from the endurance management module 48 will allow the host system to determine the total effective lifetime of the storage device from information in the storage device database on the model of card.

The storage device effective life is calculated (at 406), in one implementation, by the host system 10 assuming that the storage device 12 was brand new when first used with the host system and that all writes from the host system are made to the same storage device. Using this assumption, the predicted lifetime of the storage device may be calculated by the host system as: ((TOTAL CAPACITY×TOTAL RATED WRITE CYCLES)−(BITS WRITTEN×NUMBER OF COMPLETED WRITE CYCLES)−(INTERNAL FLASH MANAGEMENT OVERHEAD))/(TOTAL CAPACITY×TOTAL RATED WRITE CYCLES).

The specified capacity and number of write cycles (TOTAL CAPACITY AND TOTAL RATED WRITE CYCLES) for the model of storage device 12 is found in the storage device database 44, where the specified capacity is available in terms of number of physical blocks that can be written and the total rated write cycles is the number of physical block program and erase cycles. The host 10 retrieves from the storage device database 44 data on the amount of internal flash management overhead, for example the overhead of rewriting blocks for consolidation, expected for the type of storage device. Information on how many bits have been written by the host 10 to the storage device 12 and the number of program and erase cycles used to complete the writes of the bits written is retrieved from the write history database 46 on the host system 10 (at 408). The write history database 46 contains a record of all of the writes to the storage device. The result of this calculation by the host 10 is a percentage of expected life left for the storage device. Using this percentage life remaining, the host system 10 may then calculate a download speed, capacity limit adjustment or other appropriate adjustment of download policy to account for the predicted remaining life (at 410). Once the download parameters are determined, the host 10 can then make any updates to the download policies database 42 that are necessary in light of the determined download parameters (at 412).

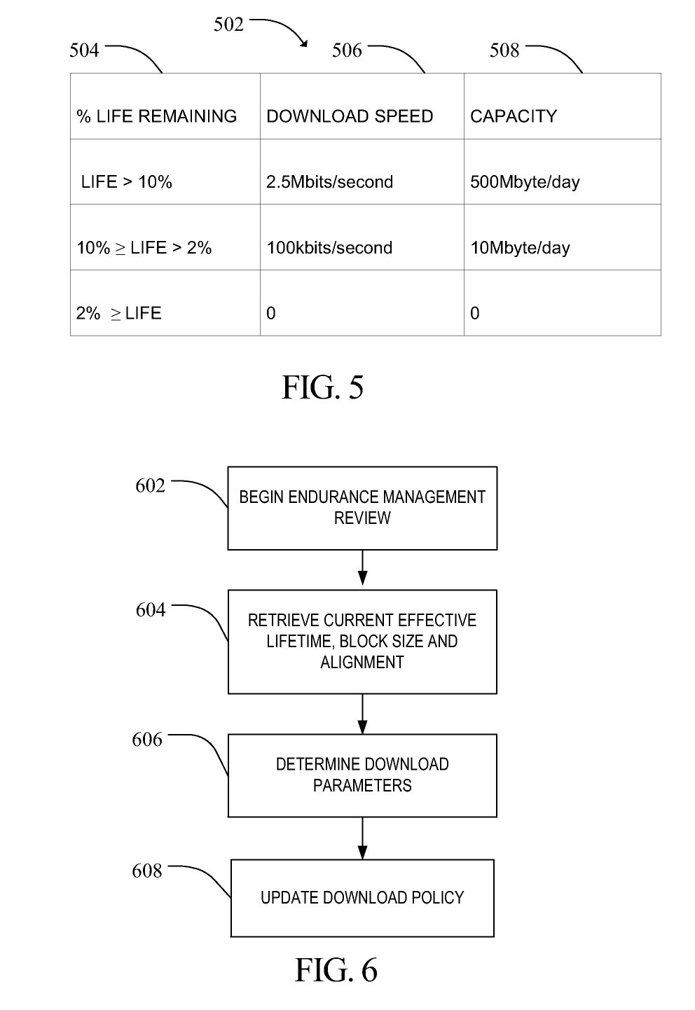

In one implementation, the calculation for determining the adjustment may be a straight comparison by the host of the calculated percentage of remaining life to a predetermined threshold level or threshold levels representing points in the remaining life of the storage device 12 where action is considered necessary. An example of such thresholds is illustrated in FIG. 5. FIG. 5 illustrates a table 502 that may be contained in the endurance management module 48 where three remaining life thresholds 504 for the storage device are associated with different speed 506 and capacity 508 limits. In the example of FIG. 5, if the calculated effective life time of the particular storage device 12 is greater than 10% remaining, the download speed and capacity is left at an unlimited setting: thus no limit is purposefully imposed and the limit is whatever general system limit there is for downloads based on overall system limitations (i.e. not related to the state of the storage device), for instance a 2.5 Megabit per second (Mb/s) rate and a 500 Megabyte per day cap. Upon a determination of predicted remaining life falling between 10 and 2 percent, the chart illustrates a reduced rate of 100 kilobit per second (Kb/s) and a lowered daily cap of 10 Megabytes. Finally, in the third tier where life remaining is less than 2% of predicted maximum, the download speed is reduced to 0 and the daily cap to 0, indicating that downloading (caching) via the automated system-driven download manager will be stopped altogether to allow the remaining life of the storage device 12 to be used up by user-driven write cycles. The three tier approach in FIG. 5 is only one contemplated way for determining a change in download speed and or capacity limits for data downloaded by the system-driven download application 38. In other implementations, more or less tiers may be utilized, or a continuous function relating the download speed and capacity to the remaining lifetime predicted for the storage device may be applied. Also, in other implementations, different values of download speed and maximum daily capacity may be used, or changes to only one of these parameters may be made.

In implementations where the memory card or other type of flash storage device 12 is capable of calculating its own end-of-life parameters, the steps of FIG. 4 may be simplified to those illustrated in FIG. 6. Referring to FIG. 6, when the endurance management module 48 steps are initiated by the processor 28 in the host 12 (at 602), rather than determining card model information and looking up data in a storage device database 42, the host 10 queries the storage device 12 for remaining lifetime, block size and block alignment information (at 604). Thus, the storage device itself will generate its current effective lifetime and provide its block size and alignment information in response to a query by the host system 10. The storage device may use any of a number of known techniques to determine its own predicted remaining life, such tracking the number of write errors, the remaining spare blocks or other metrics related to remaining write cycles. Examples of existing techniques of a storage device estimating its own expected remaining lifetime are shown in U.S. Pat. No. 7,246,268 (spare block analysis); U.S. Pat. No. 7,523,013 (parameters alone or in combination such as average cell wear, block failure rate, ECC results); and U.S. Pat. No. 7,512,847 (ratio of successfully and unsuccessfully processed data, deviation in power consumption), each of which is hereby incorporated by reference herein. The information is then directly used by the host device to compare to a table such as that illustrated in FIG. 5 to determine if any parameters such as download speed and capacity need to be modified (at 606) and then such modifications are made by updating the policy database 42 (at 608) so that the reduced maximum speed and/or capacity will be observed for the storage device going forward. In implementations where the storage device 12 can record and report endurance information, a write history database 46 does not need to be maintained by the host 10.

In addition to the particular limitations provided at the thresholds for remaining life, further limitations on download speed and capacity may be implemented by looking into the block size and block alignment information for the particular storage device. Misalignment between blocks or having block sizes that differ between the operating system format of the host device and the storage device can further add to a problem known as write amplification where these mismatches can increase the number of number of writes the controller of the storage device makes to the non-volatile memory for every write from the host system. As one way to address the block size mismatch or block misalignment, objects smaller than the storage device block size or not defined in increments of block size may be queued and grouped together by the host 10 and treated as a single object for the purpose of writing to flash and managing for download, thus reducing fragmentation.

Separately from, or in addition to, the download speed and capacity parameters that may added to or modified in the policies database 42 of the download manager, other modification of the policies database are contemplated. For example, rapidly expiring content in the queue 40 may be de-prioritized to reduce total number of writes to the card. Referring to the discussion above with the weekly episode download and the hourly sports highlight download, even if the sports highlight downloads were originally a higher priority in the download manager's queue 40, the rapidly expiring content of the sports highlights (refreshed every hour) may be limited or eliminated by the endurance management module. In this manner, higher frequency downloads can be postponed or eliminated to reduce stress on the storage device as it approaches its predicted end-of-life.

It is also contemplated that, at a given point (e.g. within a tier in FIG. 5) in the predicted life of the storage device, the cache management module of the host may modify download policy 42 base on detection of currently availability for download of an item in the queue over a high speed connection. In such a case, the availability of a high speed connection may be used to prevent any download and storage in the storage device of material scheduled for download that is currently available live via a high speed online connection. Finally, as a card begins to lose its retention capability, content may be cached to RAM 30 in the host 12 rather than the non-volatile memory 18 of the storage device 12 if it is quickly consumed by the user, especially if the user does not particularly view that particular content more than once.

A system and method for managing cache endurance has been disclosed. The system includes a host system that receives or determines a predicted remaining life of a storage device and modifies policies in a download manager to reduce or prevent some or all system-driven download, caching and frequent refreshing of large amounts of data. In one of the foregoing described embodiments, a method and system of cache endurance management includes a host device having a non-volatile memory containing a download manager and a download policy database, and a processor configured to download data from a data source to a storage device in communication with the host device in accordance with the policy database. In this embodiment the processor of the host is configured to receive information from the storage device related to a model of the storage device and calculate a predicted remaining lifetime of the storage device based on the received information. The processor of the host, executing instructions of an endurance management module on the host, determines a modification of the download policy database based on the calculated predicted lifetime and then updates the policies database of the download manager in accordance with the modification. The update to the policy database may be to add or adjust a download parameter, for example, the download rate or total daily download capacity via the download manager.

We claim:

1. A method of managing endurance of a storage device, the method comprising:
in a host having a processor, the processor:
querying a storage device in communication with the host for information relating to features of the storage device;
determining a predicted remaining life of the storage device based on the information relating to features of the storage device; and
adjusting a download policy database utilized by the host to automatically download remotely located content based on the determined predicted remaining life of the storage device.

2. The method of claim 1, further comprising receiving storage device model information in response to querying the storage device.

3. The method of claim 2, wherein determining the predicted remaining lifetime of the storage device comprises comparing the received storage device model information to a storage device model database in the host to determine a number of write cycles and capacity rated for a new storage device associated with the received storage device model information.

4. The method of claim 3, wherein determining the predicted remaining life further comprises retrieving from a write history database on the host information on an amount of data written to the storage device and a number of completed write cycles of data written to the storage device, and wherein the predicted remaining life of the storage device is based on a product of the number of write cycles and capacity for the new storage device of the storage device model less a product of the number of completed write cycles and the amount of data written to the storage device.

5. The method of claim 4, wherein determining the predicted remaining life comprises determining a percentage of life remaining for the storage device.

6. The method of claim 1, wherein adjusting the download policy database comprises adjusting one or more parameters in the download policy database to limit an ability of the host to downloaded data for storage in the storage device as the predicted remaining life decreases.

7. The method of claim 1, wherein adjusting the download policy database comprises reducing a download speed parameter in the download policy database when the predicted remaining life of the storage device is less than a first threshold.

8. The method of claim 1, wherein adjusting the download policy database comprises reducing a downloaded data capacity parameter in the download policy database when the predicted remaining life of the storage device is less than a first threshold.

9. The method of claim 7, wherein adjusting the download policy database comprises setting the download speed parameter to prevent further downloading of data when the predicted remaining life of the storage device is below a second threshold.

10. The method of claim 8, wherein adjusting the download policy database comprises setting the downloaded capacity parameter to prevent further downloading of data when the predicted remaining life of the storage device is below a second threshold.

11. A host comprising:
a memory having processor executable instructions for implementing cache endurance management; and
a processor, the processor configured to execute the processor executable instructions for implementing cache endurance management to:
query a storage device in communication with the host for information relating to features of the storage device;
determine a predicted remaining life of the storage device based on the information relating to features of the storage device; and
adjust a download policy database utilized by the host to automatically download remotely located content based on the determined predicted remaining life of the storage device.

12. The host of claim 11, wherein the storage device is integrated in the host.

13. The host of claim 11, wherein the processor is further configured to:
in response to querying the storage device, compare received storage device model information to a storage device model database in the host; and
determine a number of write cycles and capacity rated for a new storage device associated with the received storage device model information.

14. The host of claim 13, wherein the processor is further configured to:
retrieve, from a write history database on the host, information on an amount of data written to the storage device and a number of completed write cycles of data written to the storage device; and
determine the predicted remaining life of the storage device based on a product of the number of write cycles and capacity rated for the storage device less a product of the number of completed write cycles and the amount of data written to the storage device.

15. The host of claim 11, wherein the processor is further configured to adjust the download policy database by adjusting one or more parameters in the download policy database to limit an ability of the host to downloaded data for storage in the storage device as the predicted remaining life decreases.

16. The host of claim 15, wherein the processor is configured to adjust the download policy database to reduce a download speed parameter in the download policy database when the predicted remaining life of the storage device is less than a first threshold.

17. The host of claim 15, wherein the processor is configured to adjust the download policy database to reduce a downloaded data capacity parameter in the download policy database when the predicted remaining life of the storage device is less than a first threshold.

18. The host of claim 16, wherein the processor is configured to adjust the download policy database to set the download speed parameter to prevent further downloading of data when the predicted remaining life of the storage device is below a second threshold.

19. The host of claim 17, wherein the processor is configured to adjust the download policy database to set the downloaded capacity parameter to prevent further downloading of data when the predicted remaining life of the storage device is below a second threshold.

20. The host of claim 11, wherein the memory having processor executable instructions for implementing cache endurance management comprises non-volatile memory in the host.

21. A method of managing endurance of a storage device, the method comprising:
in a host having a processor, the processor:
querying a storage device in communication with the host for a predicted remaining life of the storage device;
determining download parameters for a download policy database in the host based on the predicted remaining life of the storage device received from the storage device, the download policy database comprising parameters utilized by the host to control automatic download of remotely located content; and
updating the download policy database in the host with the determined download parameters.

22. A host comprising:
a memory having processor executable instructions for implementing cache endurance management; and
a processor, the processor configured to execute the processor executable instructions for implementing cache endurance management to:
query a storage device in communication with the host for a predicted remaining life of the storage device;
determine download parameters for a download policy database in the host based on the predicted remaining life of the storage device received from the storage device, the download policy database comprising parameters utilized by the host to control automatic download of remotely located content; and
update the download policy database in the host with the determined download parameters.

23. The host of claim 22, wherein the memory having processor executable instructions for implementing cache endurance management comprises non-volatile memory in the host.
